(19) United States
(12) Patent Application Publication
(10) Pub. No.: US 2007/0013248 A1
(43) Pub. Date: Jan. 18, 2007

(54) Electric machine with axial compensating element, actuator with an electric machine of this type as well as use of an electric machine of this type in a motor vehicle

(76) Inventors: Gerald Viernekes, Hassfurt (DE); Klaus Zaps, Volkach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/456,970

(22) Filed: Jul. 12, 2006

(30) Foreign Application Priority Data
Jul. 13, 2005 (EP) 05015233

(51) Int. Cl. H02K 5/16; F16C 33/02

(52) U.S. Cl. 310/90; 384/276

(57) ABSTRACT

The electric machine has a stator, a rotor with a rotor shaft and a bearing. One end of the rotor shaft is guided in the bearing which is inserted into a clamping nut in the axial direction. The clamping nut is fixed into a housing together with the bearing. The clamping nut forms a pot bearing, which axially limits the end of the rotor shaft guided by the bearing. The pot bearing is an axially tapered cylindrical appendage of the clamping nut which forms a springing element acting essentially axially for a possible axial movement of the pot bearing. The clamping nut effects the attachment of the engine-side bearing in the housing of the electric machine and at the same time an axial limitation of the rotor shaft in the sense of a tolerance compensation or axial compensation. The component and assembly complexity for the electric machine are hereby reduced.

### PRIORITY

This application claims priority from European Patent Application No. EP05015233, which was filed on Jul. 13, 2005, and is incorporated herein by reference in its entirety.

### TECHNICAL FIELD

The invention relates to an electric machine comprising a stator, a rotor with a rotor shaft and a bearing. One end of the rotor shaft is guided in a bearing, which is inserted into a clamping nut in an axial direction. The clamping nut is fixed in a housing of the electric machine together with the bearing. The invention additionally relates to an actuator with a transmission system and an electric machine of this type. Such an electric machine can be used for instance in the field of motor vehicles and can be used there as a window lifter motor or as a pump drive system for instance.

### BACKGROUND

Electric machines, such as electric motors for instance, are also required to drive an actuator, such as for instance a window lifter motor or a drive to actuate the sliding sunroof. Besides the electric machine, this type of actuator also comprises a transmission system. In this case, the transmission system can feature a worm gear for instance and a transmission shaft realized as a worm shaft. The electric machine comprises a stator arranged in a housing of the electric machine as well as a rotor. The rotor comprises a rotor shaft and/or a motor shaft as well as rotor packet containing a plurality of disks and attached to the rotor shaft. The transmission shaft and rotor shaft can also be designed in one-piece as a combined rotor shaft or transmission shaft.

Axial play compensation elements are provided to compensate for manufacturing-specific and assembly-specific tolerances. These can be positioned between the rotor shaft and the transmission shaft, between the transmission shaft and the transmission casing and/or between the rotor shaft and the housing of the electric machine. In the case of a combined rotor shaft, axial play compensation elements are provided in the end region of the rotor shaft on the motor side or on the transmission side. For manufacturing and assembly-related reasons, a complete balancing of the tolerances can however not be carried out by means of this type of compensation elements. There is always a residual clearance of up to 0.2 mm.

Solving this problem by measuring the residual gap is known. The axial compensation is then effected via compensation elements of different strengths.

Alternatively, a certain axial compensation can be effected via spring elements such as compression springs or elastomers for instance which are deposited as a separate element in a pot bearing. However, by virtue of their minimal spring stiffness, these spring elements instead form a stop damping for the rotor shaft during a change in load or during a change in the direction of rotation of the electric machine and/or of the actuator.

GB 2 152 294 A discloses a bearing housing for the bearing of the motor shaft of an electromotor. The bearing housing is manufactured from a plastic. In addition, the bearing housing forms a clamping nut, into which can be inserted a spherical cup bearing. A thin plastic film of the bearing housing, which faces the end of the motor shaft, forms an axial stop damping.

### SUMMARY

The object of the invention is thus to specify an electric machine which requires fewer components for an axial compensation.

This object can be achieved by an electric machine comprising a stator, a rotor with a rotor shaft and a bearing, with an end of the rotor shaft being guided in the bearing, the bearing being inserted into a clamping nut in the axial direction, and the clamping nut being fixed into a housing of the electric machine together with the bearing, wherein the clamping nut forms a pot bearing, which axially limits the end of the rotor shaft guided by the bearing.

The pot bearing can be an axially tapered cylindrical appendage of the clamping nut. The axial tapering may form a spring element acting essentially axially. The pot bearing may comprise lateral recesses and the remaining bars may form the spring element in the tapering area. The exterior of the pot bearing facing the end of the rotor shaft may have an elastic coating. The bearing for guiding the rotor shaft can be a spherical cap, which can be inserted into a receiving opening of the clamping nut corresponding thereto. The clamping nut may comprise first flat springs arranged in an annular fashion, which enclose and fix the outer circumference of the spherical cup in a latching arrangement. The clamping nut may comprise second finger springs which, viewed in the radial direction, are arranged outside the first finger springs and which form a collar for axial and radial fixing of the clamping nut in the housing of the electric machine. The clamping nut can be manufactured from sheet metal in a punching and bending process. The sheet metal can be a spring steel sheet. An actuator may comprise a transmission system and such an electric machine comprising a rotor shaft. Furthermore, such an electric machine may be used in a motor vehicle.

With the electric machine according to the invention, the clamping nut, into which the bearing is axially inserted to guide the rotor shaft, forms a pot bearing. The pot bearing is dimensioned here so that it axially limits the end of the rotor shaft guided by the bearing.

The significant advantage of the invention stems from the fact that the clamping nut, as a single component, effects the fixing of the bearing in the housing of the electric machine and at the same time effects an axial limitation of the rotor shaft in the sense of a tolerance or axial compensation.

Furthermore, the component and assembly expenditure for an electric motor is hereby advantageously reduced.

In particular, the pot bearing is an axially tapered cylindrical appendage of the clamping nut. Here, the cylindrical appendage surrounds the end of the rotor shaft. The “pot base” preferably forms a flat area, which axially limits the likewise preferably flat end of the rotor shaft. If the rotor shaft is mounted in an actuator for instance, axial play is advantageously prevented to a certain degree. The axial tapering can also take the form of a step, in particular a bevelled step.

In an advantageous embodiment, the axial tapering forms an essentially axially acting spring element. This allows an axial compensation movement of the pot bearing. The springing is based here on elastic bending moments, which are determined on the one hand by the geometry of the spring element, such as for instance the bending angle and by the material thickness in the tapering, and on the other hand, by the material properties such as for instance the module of elasticity of the material used for the clamping nut.

In a particular embodiment, lateral recesses are provided in the pot bearing, with the then remaining spring bars forming the spring element in the tapering region. In this way, a less stiffly sprung variant can be effected in comparison with the previous embodiment. In particular, the spring elements have a spring hardness in a region of 40 N/mm to 80 N/mm. An axial tolerance compensation of up to 0.4 mm can be achieved in this way. In addition, the above-mentioned region of the spring hardness advantageously ensures that the rotor shaft can be mounted in the actuator for instance in a sufficiently rigid manner.

In a preferred embodiment, the exterior of the pot bearing facing the end of the rotor shaft has an elastic coating. This side can be coated for instance with a thin layer of natural rubber of less than 1 mm. The clamping nut is hereby advantageously extended by the function of a stop damping. The rotor shaft impacts against the housing of the electric machine above all during a change of load or a change in the direction of rotation of the electric machine and/or of the actuator. The forces occurring in this case are greater by a multiple in comparison with the axially desired maximum pre-stress forces of the rotor shaft such as 25 N for instance. The thin elastic coating allows the impact of the rotor shaft on the housing of the electric machine to be damped such that the impact noise occurring moves in a reliable and non-disturbing frame.

In a particular embodiment, the bearing for guiding the rotor shaft is a spherical cap, which can be inserted into a receiver opening of the clamping nut corresponding thereto. In this way, the spherical cup comprises a spherical exterior surface, which can move within certain boundaries in a spherical shell of the clamping nut corresponding thereto. The cup's spherical cap advantageously enables deflections and radial offsets of the rotor shaft to be compensated for. The clamping nut, which encompasses the spherical cup, herewith effects a permanent prestressing so that the spherical cap remains fixed in its position after the electric machine has been assembled.

In a further embodiment, the clamping nut comprises a first finger and/or flat spring arranged in an annular fashion, which latches onto the exterior circumference of the spherical cap to surround and fix it.

The assembly of the electric machine is hereby significantly simplified. To this end, within the scope of the assembly, the spherical cap is inserted into the corresponding opening of the clamping nut in an axial direction. The flat springs simultaneously spreading in the axial and the radial direction advantageously effect a centering of the spherical cap, before this is finally latched by snapping into the opening of the clamping nut. At the same time, the springing of the flat spring is dimensioned such that a simple assembly and a secure fixing of the spherical cap in the opening are possible.

In a further advantageous embodiment, the clamping nut comprises second flat springs, which, viewed in a radial direction, are arranged outside the first flat springs and which form a flange to axially and radially fix the clamping nut in the housing of the electric machine. The flange can preferably be fixed and/or clamped in an annular recess in the housing of the electric machine. In this case, the ends of the second finger and/or flat springs pointing slightly in the radial direction effect a reliable clamping of the clamping nut with the annular recess in the housing of the electric machine.

Preferably, the clamping nut can be manufactured from sheet metal in a punching and bending process, in particular from a spring steel sheet. After die-cutting the two-dimensional punching contour pertaining to the clamping nut, the clamping nut is bent and/or deformed into its final spatial shape by means of a deep drawing method.

A clamping nut of this type can be manufactured particularly simply and cost-effectively in this way.

An electric machine according to the invention can be used advantageously in a motor vehicle, since in particular, a large number of compact electric machines, such as for instance for window lifting or for opening and closing a sliding sunroof, is required there.

### BRIEF DESCRIPTION OF THE DRAWINGS

Further advantageous characteristics of the invention emerge from their exemplary explanation with reference to the figures, in which;

FIG. 1 shows a cross-sectional view of an exemplary actuator with a transmission system and an electric machine according to the invention,

FIG. 2 shows an enlarged cross-sectional illustration of the electric machine according to FIG. 1, which shows a spherical cap according to the invention accommodated in an exemplary clamping nut with pot bearing,

FIG. 3 shows a perspective view of the clamping nut according to the invention with the spherical cap not yet inserted,

FIG. 4 shows a perspective view of the clamping nut according to the invention with the spherical cap inserted and

FIG. 5 shows an enlarged illustration of the exemplary clamping nut with pot bearing and the spherical cap clamped therein according to the cross-sectional view from FIG. 2.

### DETAILED DESCRIPTION

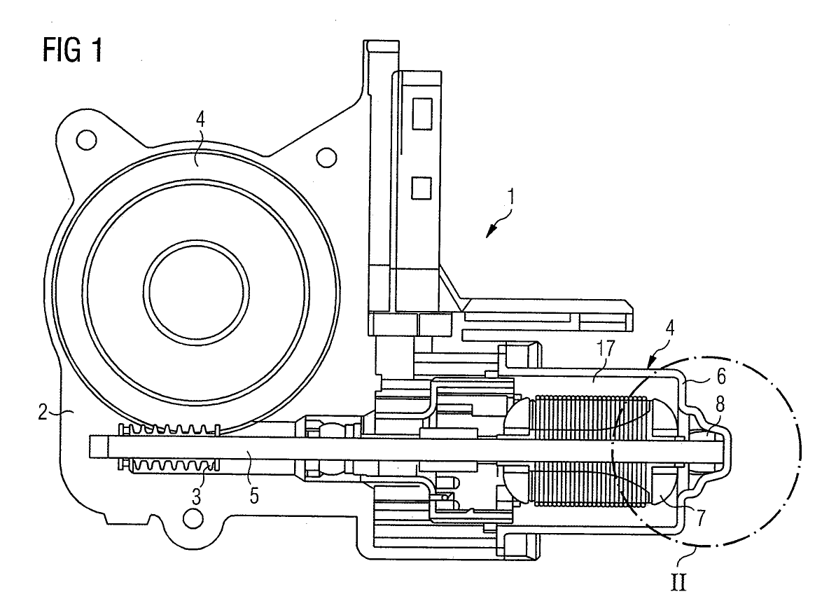

FIG. 1 shows a cross-sectional view of an exemplary actuator 1 with a transmission system 2 and an electric machine 4 according to the invention. The transmission system 2 comprises a transmission casing, in which a worm gear and a worm shaft 3 engaging in the worm gear are accommodated. The electric machine 4 comprises a housing 6, a stator 17 and a rotor 7 for the motor drive accommodated therein. The worm shaft 3 is seated on the free end of the rotor shaft 5, with a rotor shaft 5 being driven by the electric machine 4 and being partially accommodated in the housing 6 of the electric machine 4. The rotor shaft 5 is guided into a bearing 8 which receives the motor side end of the rotor shaft 5, as well as into a further bearing facing the transmission system 2. In the example in FIG. 1, the rotor shaft 5 is designed in one piece. A two-piece design of the rotor shaft 5 in a motor shaft and a transmission shaft is likewise conceivable with an intermediary connecting link.

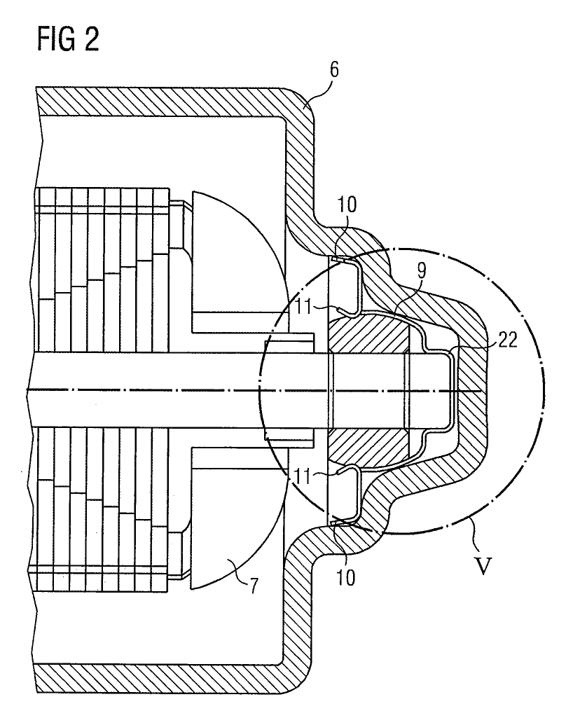

FIG. 2 shows an enlarged illustration of the electric machine 4 in a cross-sectional illustration according to FIG. 1. The cross-sectional illustration shows a spherical cap 8 according to the invention accommodated in an exemplary clamping nut 9 with a pot bearing 22. The clamping nut 9 fixes the inserted spherical cap 8 by means of first finger and/or flat springs 11. The restoring force of the flat springs 11 causes the spherical cap 8 to remain fixed in the corresponding spherical opening of the clamping nut 9.

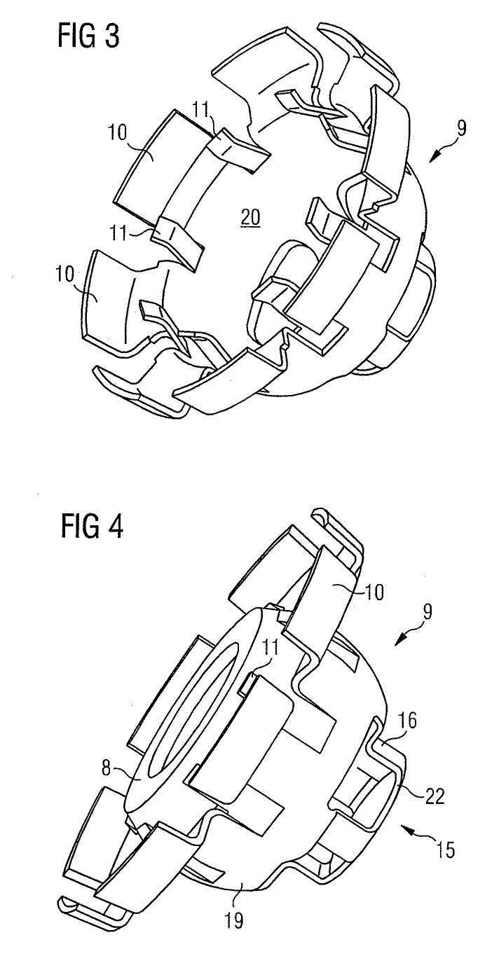

FIG. 3 shows a perspective view of the clamping nut 9 according to the invention with a spherical cap 9 not yet inserted. A clamping nut 9 of this type is to be manufactured in particularly simple and cost-effective manner by means of a punching method and bending method. The present FIG. 3 shows that such a clamping nut 9 can be manufactured from a piece of sheet metal. In this context, the arrangement of the inner and outer finger and/or flat springs 11/10 displaced against each other is advantageous.

FIG. 4 shows a perspective view of the clamping nut 9 according to the invention with inserted spherical cap 9. In addition, FIG. 4 shows the contour 19 of the receiver opening 20 of the spherical cap 8 matched to the spherical exterior contour of the spherical cap 8. This arrangement allows an advantageously possible twisting and tipping of the spherical cap 8 in the corresponding opening 20 of the clamping nut 9, so that radial offsets and deflections of the rotor shaft 5 can be compensated for during manufacture and assembly.

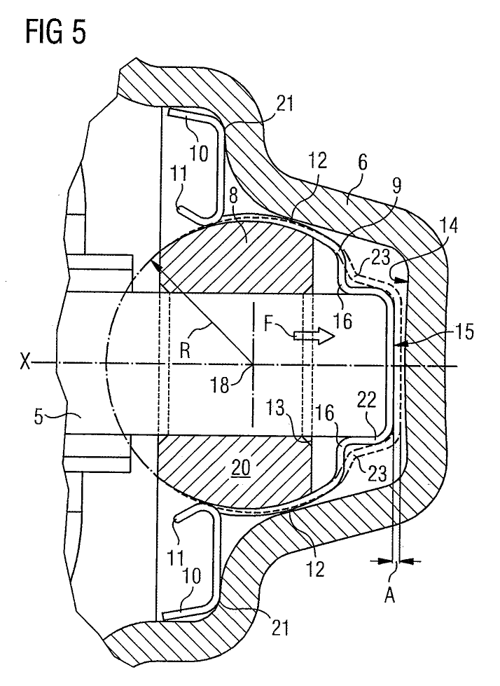

FIG. 5 shows an enlarged illustration of the exemplary clamping nut 9 with a pot bearing 22 and the spherical cap 8 clamped therein according to the cross-sectional illustration from FIG. 2. R shows the radius of the spherical shape of the spherical cap 8, which is accommodated in a spherical opening of the clamping nut 9. The clamping nut 9 is fixed in an annular recess of the housing 6 of the electric machine 4 by means of the collar 21 formed by the second flat springs 10. At the same time, the clamping nut 9 lies on the housing 6 of the electric machine 4 at points 12, so that axial forces F in the direction towards the end of the rotor shaft 5 now lead to a deflection A of the pot bearing 22 for an axial compensation. This case occurs for instance when the combined rotor shaft 5 is mounted and clamped in the actuator 1, with the longitudinal dimensions of the rotor shaft 5 lying in the upper tolerance band for manufacturing and assembly of the actuator. For the case of movement, the spring elements 23 lying in the tapering extend according to a dashed contour line. The contour of the spring elements is plotted using the reference character 16, such that only a minimal axial force is present in the direction towards the end of the rotor shaft 5. This case occurs for instance when the longitudinal dimensions of the rotor shaft 5 lie in the lower tolerance band.

In the case of a change of load or a change in the direction of rotation of the actuator 1, the side 15 facing the “pot base” impacts against a corresponding side 14 of the motor housing 6. The stop noise is significantly damped by means of a thin elastic coating 25 (see FIG. 2) applied to the side 15 facing the “pot base”.

What is claimed is:

1. An electric machine comprising a stator, a rotor with a rotor shaft and a bearing, with an end of the rotor shaft being guided in the bearing, the bearing being inserted into a clamping nut in the axial direction, and the clamping nut being fixed into a housing of the electric machine together with the bearing,
wherein
the clamping nut forms a pot bearing, which axially limits the end of the rotor shaft guided by the bearing.

2. An electric machine according to claim 1,
wherein
the pot bearing is an axially tapered cylindrical appendage of the clamping nut.

3. An electric machine according to claim 2,
wherein
the axial tapering forms a spring element acting essentially axially.

4. An electric machine according to claim 3,
wherein
the pot bearing comprises lateral recesses and the remaining bars form the spring element in the tapering area.

5. An electric machine according to claim 1,
wherein
the exterior of the pot bearing facing the end of the rotor shaft has an elastic coating.

6. An electric machine according to claim 1,
wherein
the bearing for guiding the rotor shaft is a spherical cap, which can be inserted into a receiving opening of the clamping nut corresponding thereto.

7. An electric machine according to claim 6,
wherein
the clamping nut comprises first flat springs arranged in an annular fashion, which enclose and fix the outer circumference of the spherical cup in a latching arrangement.

8. An electric machine according to claim 7,
wherein
the clamping nut comprises second finger springs which, viewed in the radial direction, are arranged outside the first finger springs and which form a collar for axial and radial fixing of the clamping nut in the housing of the electric machine.

9. An electric machine according to claim 1,
wherein
the clamping nut can be manufactured from sheet metal in a punching and bending process.

10. An electric machine according to claim 9,
wherein
the sheet metal is a spring steel sheet.

11. An actuator with a transmission system and an electric machine comprising a rotor shaft according to claim 1.

12. A method of using an electric machine according to claim 1 in a motor vehicle.

13. An electric machine comprising a stator, a rotor with a rotor shaft and a bearing, with an end of the rotor shaft being guided in the bearing, the bearing being inserted into a clamping nut in the axial direction, and the clamping nut being fixed into a housing of the electric machine together with the bearing,
wherein
the clamping nut forms a pot bearing, which axially limits the end of the rotor shaft guided by the bearing,
the pot bearing is an axially tapered cylindrical appendage of the clamping nut,
the axial tapering forms a spring element acting essentially axially,
the pot bearing comprises lateral recesses, and
the remaining bars form the spring element in the tapering area.

14. An electric machine according to claim 13,
wherein the exterior of the pot bearing facing the end of the rotor shaft has an elastic coating.

15. An electric machine according to claim 13,
wherein the bearing for guiding the rotor shaft is a spherical cap, which can be inserted into a receiving opening of the clamping nut corresponding thereto.

16. An electric machine according to claim 15,
wherein the clamping nut comprises first flat springs arranged in an annular fashion, which enclose and fix the outer circumference of the spherical cup in a latching arrangement.

17. An electric machine according to claim 16,
wherein the clamping nut comprises second finger springs which, viewed in the radial direction, are arranged outside the first finger springs and which form a collar for axial and radial fixing of the clamping nut in the housing of the electric machine.

18. An electric machine according to claim 13,
wherein the clamping nut can be manufactured from sheet metal in a punching and bending process.

19. An electric machine according to claim 18,
wherein the sheet metal is a spring steel sheet.

20. An electric machine comprising a stator, a rotor with a rotor shaft and a bearing, with an end of the rotor shaft being guided in the bearing, the bearing being inserted into a clamping nut in the axial direction, and the clamping nut being fixed into a housing of the electric machine together with the bearing,
wherein
the clamping nut forms a pot bearing, which axially limits the end of the rotor shaft guided by the bearing,
the bearing for guiding the rotor shaft is a spherical cap, which can be inserted into a receiving opening of the clamping nut corresponding thereto,
the clamping nut comprises first flat springs arranged in an annular fashion, which enclose and fix the outer circumference of the spherical cup in a latching arrangement, and
the clamping nut comprises second finger springs which, viewed in the radial direction, are arranged outside the first finger springs and which form a collar for axial and radial fixing of the clamping nut in the housing of the electric machine.
